(19) United States
(12) Patent Application Publication
(10) Pub. No.: US 2009/0013286 A1
(43) Pub. Date: Jan. 8, 2009

(54) Method and Apparatus for Authoring and Storing Media Objects in Optical Storage Medium

(76) Inventor: Jiunn-Sheng YAN, Taipei (TW)

Correspondence Address: Jiunn-Sheng Yan, No. 28, Lane 46, Sec. 1, Dirhua St., Taipei, TW

(21) Appl. No.: 12/234,675

(22) Filed: Sep. 21, 2008

Related U.S. Application Data
(63) Continuation-in-part of application No. 11/177,613, filed on Jul. 8, 2005.

(51) Int. Cl. G06F 17/00

(52) U.S. Cl. 715/818

(57) ABSTRACT

A method and apparatus for authoring and storing media objects in an optical storage medium, including the steps of: (a) providing two or more built-in menus, each built-in menu including at least one built-in navigation command; (b) associating the media objects each to a dedicated navigation command so as to establish a one-on-one relationship between the media objects and the navigation commands, wherein the one-on-one relationship between the media objects and the navigation commands is of a number substantially limited by capacity of the optical storage medium; and (c) arranging the navigation commands such that the navigation commands are distributed among the built-in menus and defining the media objects each to be a menu.

### CROSS-REFERENCE TO RELATED APPLICATION

The present invention is a Continuation-In-Part of U.S. application Ser. No. 11/177,613, filed on Jul. 8, 2005.

### BACKGROUND OF THE INVENTION

1. Field of the Invention

The present invention relates to a method and apparatus for authoring and storing media objects in optical storage medium, particular to one where only one media object would be displayed upon activation of the corresponding navigation command, while the number of data-command relationship is substantially limited by the capacity of the optical storage medium.

2. Description of the Related Art

The use of digital cameras is rapidly proliferating and they may one day overtake 35 mm SLR's in terms of worldwide sales. There are basically three types of digital cameras; digital still cameras, digital video cameras, and hybrid digital-video cameras.

Still digital cameras are used primarily for capturing high quality static photographs, and offer a less expensive alternative to digital video cameras. Still digital cameras are typically less expensive because they have far less processing power and memory capacity than digital video cameras.

Digital video cameras differ from digital still cameras in a number of respects. Digital video cameras are used to capture video at approximately thirty frames per second at the expense of image quality. Digital video cameras are more expensive than still cameras because of the extra hardware needed. The uncompressed digital video signals from all the low-resolution images require huge amounts memory storage, and high-ratio real-time compression schemes, such as MPEG, are essential for providing digital video for today's computers.

Hybrid digital-video cameras, also referred to as multimedia recorders, are capable of capturing both still JPEG images and video clips, with or without sound. One such camera is the M2 Multimedia Recorder by Hitachi America, Ltd., Brisbane, Calif.

Almost all still digital cameras now store the images and/or videos on a high capacity storage device, such as flash memory, CF card, MMC card, SD card mini-SD card, etc., which provides random access to the recorded image data.

Since digital cameras capture images and sound in digital format and then stores such media objects in the high capacity storage devices, the user needs to frequently back up the media objects to a Hard Disk Drive (HDD). To prevent from overloading the HDD, if the information is enormous, a majority of users even back up the media objects to an optical storage medium. The media object files may be simply “stored” in an optical storage medium without any editing or authoring. This approach though simple, fails to allow viewing of the media objects through DVD-players by means of navigation commands defined by DVD Specification approved by the Digital Video Disc (DVD) forum. Though some newly developed DVD-players provide the playback of such media objects not recorded in the optical storage medium in the form approved by the DVD form, the user still need to press “pause” and “forward” buttons provided by the DVD-players to view the electronic files one by one in a sequential manner.

Structure of a DVD-Video Disc

The DVD-Video disc (referred to DVD hereinafter) development is on a considerable growth path, almost doubling every year. This growth will continue in the coming years, as more DVD based applications emerge. Combining the dual benefits of high multimedia quality and reliable data storage capabilities, the DVD offers an opportunity for the emergence of several new system developments. One function of DVD in the consumer electronics sector (such as DVD-players) is to playback and recording of video/audio and image captured.

A DVD-video disc is divided into video Title sets (or video title, titles). As a minimum there will be one Video Manager (VMG) and one VTS as shown in FIG. 7. VMG contains information and the data to control one or more VTS and Video Manager Menu (VMGM). Each Video Title Set (VTS) comprises control data and Video Objects (VOBs) for both menus and titles. Each VOB comprises video, audio, subpictures and navigation data. When VOB is played the player not only plays the video sequentially but also obeys the navigation commands for displaying menus, getting user selections etc. Each VOB comprises the individual cells linked together by program chains (PGCs), which provide the necessary interactivity using a simple programming language developed for DVD-video. PGCs are used to control the playing of video, audio and subtitles in VOBs, to display menus and input and obey user commands.

DVD-Video Features

The features are the choice of the choice of widescreen, letter box and pan & scan video formats, audio in up to 8 languages, subtitles for a further 32 languages, 133 minutes of high quality MPEG-2 encoded video with multi-channel surround sound audio, menus and program chains for user interactivity, up to 9 camera angles to give the user more choice, digital and analogue copy protection and parental control for protection of children. Among such features, interactive menus (or menus) comprise MPEG stills or moving video (usually referred to as “motion menu”) with overlaid subpictures for highlighting menu buttons when selected or for providing additional text/graphics. When the user selects a menu button, which corresponds to a navigation command of specific functionality, it must be highlighted to indicate which button is active, which is usually done by using subpictures and changing the color(s). Common uses include selecting different scenes in a movie, and changing language or subtitles options, accessing special features, etc.

DVD System Model

In the DVD-Video zone two types of data are included, namely, (1) Navigation Data, the general name for the playback control data, such as navigation commands and buttons, and (2) Presentation Data, the general name for the data to be played, such as Video, Audio, Sub-pictures, etc.

The DVD-player plays back the Presentation Data based on the Navigation Data and playback conditions used by the user. In the player, the Navigation Manager performs the transactions that determine the playback conditions, while the Presentation Engine performs the transactions that decode and playback, as schematically shown in FIG. 8.

Prior Applications of DVD-Video Discs for Backing Up Media Objects

Many software applications have thus been developed for backing up media objects to DVD-Video discs by editing and authoring media objects meeting the DVD specification approved by the DVD forum, which facilitates viewing of such media objects by means of widely available electronic consumer appliance, such as DVD-players. The media objects to be backed up from the storage devices may include at least one media type such as, a still image and a video with or without accompanying audio. For videos, currently available techniques would simply back up such in an optical storage medium as video titles that will be displayed (played back) upon activating their corresponding navigation commands associated thereto. For still images, currently available techniques for backing up such in an optical storage medium, however, would need to convert still images into “slideshows,” where each slideshow may include numerous still images that are recorded in the optical storage medium as a “video title.” Under such situations, activation of the navigation commands associated to the corresponding “slideshows” (which are in fact in the form of videos) would display (play back) the still images included in the slide shows in a sequential order, with predefined time intervals between two consecutive still images for a defined duration, rather than viewing one still image at a time. The commercially available applications, such as MyDVD®, DVDit®, Video Studio®, Picture Show®, Power Producer®, Power Director®, Roxio Easy Media Creator®, Pinnacle Studio®, Nero PhotoShow Elite®, NTI CD & DVD Maker®, ArcSoft ShowBiz DVD®, ArcSoft DVD SlideShow®, DVD Photo Slideshow®, MAGIX PhotoStory On CD&DVD 2005®, Photo DVD Maker®, DVD PhotoPlay®, DVD Maker®, HT Photo DVD®, Slideshow Pro®, Triscape FxFoto®, MemoriesOnTV®, DVD-Lab®, DVD Photo Slideshow®, VSO PhotoDVD®, DVD PixPlay®, PhotoImpact®, Photo Explosion Deluxe®, Muvee®, PhotonTV®, InAlbum®, TV SlideShow Studio®, Presto! Mr. Photo Platinum®, Presto! DVD PowerSuite®, Screenblast Movie Studio®, SureThing Photo Plus®, InterVideo DVD SlideShow®, Ulead Photo Explorer®, etc., all adopt the above techniques for backing up videos and still images in optical storage medium.

The underlying reason for the need to convert numerous still images into videos prior to storing in the optical storage medium is that, according to the DVD Specifications approved by DVD Forum, the maximum number of Titles (video titles) that may be recorded in an optical storage medium, such as CD-R (in the form of mini-DVD), CD-RW (in the form of mini-DVD), DVD+R, DVD-R, DVD+RW, DVD-RW and DVD-DL, is set to be 99. It is worthy to note that, though CD-R and CD-RW in the from of mini-DVD, DVD+R and DVD+RW have not been formally recognized by the DVD forum upon until now, most commercially available DVD-players are able to access Representation Data and Navigation Data stored therein.

Thus, if each still image is recorded in the optical storage medium as a single video title, the maximum number of still images and videos that may be recorded in one optical storage medium would be 99, despite the fact that there may still be storage capacity remained in the optical storage medium. To fully utilize the 640 MB, 4.7 GB or 9.4 GB storage capacity available on various types of optical storage medium, numerous images were thus converted into a video that would playback as a slideshow.

However, slideshows involve the drawbacks that the user cannot pause the playback of the slideshow when he/she intends to view a single still image among the numerous still images contained in the slideshow, unless the user presses the “pause” button provided by the DVD-player at the right time. Furthermore, it is relatively difficult for the user to identify locations of specific still images of interest from multiple navigation commands associated with corresponding slideshows, as the navigation commands may not contain sufficient information with respect to the still images contained therein, or even if such information is available, it usually flashes over the display screen, which fails to serve proper identification purpose. Sometimes, it is necessary for the user to activate all navigation commands so as to playback all slideshows before he/she can actually locate the still images of interest. Another drawback is that, even if the user can locate the navigation command associated with the slideshow including the still image of interest, if such still image is arranged at near the end of the slideshow, the user would need to wait until all the preceding still images have been displayed prior to actually viewing the still image of interest, unless the user presses the “forward” button provided by the DVD-player and then stop at the right time, subsequently followed by pressing the “pause” button in order to stop at the still image of interest. Such operations, apparently, is inconvenient and cumbersome, especially for people who are not familiar with DVD operations.

FIG. 1 is a schematic drawing illustrating the conventional approach of editing still images stored in an optical storage medium, in which three exemplified still images are included in a single slideshow with a 10 sec interval between two consecutive still images A, B, C. Apparently, such a viewing approach is different from the conventional “album-like” viewing habit known by the user who can flip through the pages, stop at any photograph of interest, and/or take a closer look of the photograph of interest. The user may then flip to the next pages to continue viewing of the photographs that are pasted to the album.

Due to the limitations of the DVD Specification approved by the DVD forum, the user is forced to learn how to operate a DVD-player in order to “pause” and “fast forward” the slideshows, to focus on the navigation commands that may “flash through” the still images contained in the slideshows associated to the commands, and to learn a new habit of viewing pictures. As the use of digital cameras becomes increasingly mainstreamed, however, the number of novice DVD-player users will increase. Indeed, many users will even refuse from using a DVD-player if complicated operations are needed to view the images container therein. Therefore, many camera owners will be precluded from taking advantage of the multimedia capabilities provided by digital cameras and the great storage capacity provided by optical storage medium in conjunction with the high quality viewing capability provided by DVD-players over a display monitor or screen.

What is needed is an improved method for authoring and storing media objects in optical storage medium, where only one media object would be displayed upon activation of the corresponding navigation command, while the number of data-command relationship is substantially limited by the capacity of the optical storage medium, such that the images/video stored in the optical storage medium can be displayed (played back) in a conventional “album-like” manner. The present invention addresses such needs.

### SUMMARY OF THE INVENTION

The present invention provides a method and apparatus for authoring and storing media objects in an optical storage medium. The authoring method aspect of the present invention includes the steps of: (a) providing two or more built-in menus, each built-in menu including at least one built-in navigation command; (b) associating the media objects each to a dedicated navigation command so as to establish a one-on-one relationship between the media objects and the navigation commands, wherein the one-on-one relationship between the media objects and the navigation commands is of a number substantially limited by capacity of the optical storage medium; and (c) arranging the navigation commands such that the navigation commands are distributed among the built-in menus and defining the media objects each to be a menu.

The storing method aspect of the present invention includes the steps of (a) reading media objects from a storage device; (b) associating the media objects each to a dedicated navigation command so as to establish a one-on-one relationship between the media objects and the navigation commands, wherein the one-on-one relationship between the media objects and the navigation commands is of a number substantially limited by capacity of the optical storage medium; and (c) recording the media objects and the navigation commands associated to the corresponding media objects to the optical storage medium.

According to a specific embodiment of storing method, the method includes the steps of: (a) reading media objects from a storage device; (b) associating the media objects each to a dedicated navigation command so as to establish a one-on-one relationship between the media objects and the navigation commands, wherein the one-on-one relationship between the media objects and the navigation commands is of a number substantially limited by capacity of the optical storage medium; (c) defining the media objects each to be a menu in the optical storage medium; (d) providing at least one built-in menu, each built-in menu including at least one built-in navigation command; (e) arranging the navigation commands such that at least one navigation command is associated to and overlaying the at least one built-in menu; (f) recording the media objects defined by the menus, the navigation commands associated to the corresponding media objects, and the at least one built-in menu associated to and containing the navigation commands to the optical storage medium.

When the authoring and/or recording is completed and images/videos are stored in an optical storage medium for user's viewing through a DVD-player, each one of the media objects stored in the optical storage medium is displayed on a display screen only upon activation of the navigation command associated to corresponding image/video, without the need to glance through other video/image not of interest. According to the present invention, the user is able to view the image/video of interest as long as he/she wishes until he/she navigates to leave the still image of interest. The user may even “zoom-in” or “pan” the still image of interest by pressing the built-in navigation commands that have been pre-authored into the menu defined by the media objects in the optical storage medium.

According to yet another aspect of method for authoring and storing media objects in an optical storage medium, where the media objects each having more than one segments and stored in an optical storage medium, the authoring method comprising the steps of: (a) providing two or more built-in menus; (b) associating each starting point of the segments of the media objects to a dedicated navigation command so as to establish a one-on-one relationship between the starting points of the segments and the navigation commands; and (c) arranging the navigation commands such that the navigation commands are distributed among the built-in menus.

### BRIEF DESCRIPTION OF THE DRAWINGS

The foregoing aspects and many of the attendant advantages of the present invention will become more readily appreciated as the same becomes better understood by reference to the following detailed description, when taken in conjunction with the accompanying drawings, wherein:

FIG. 1 is a schematic drawing illustrating the conventional approach of editing still images stored in an optical storage medium;

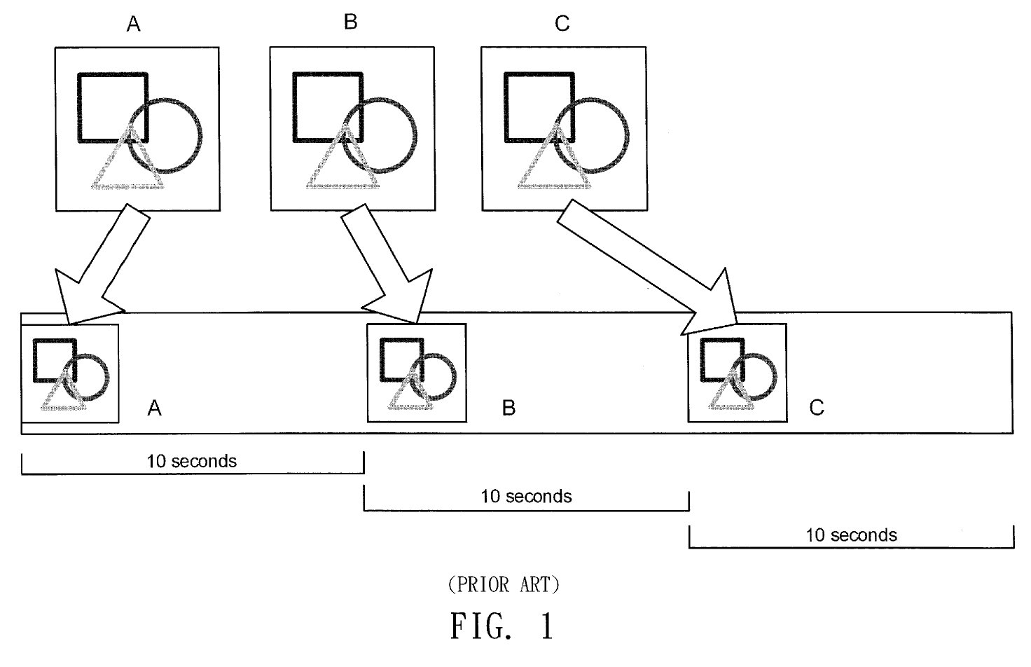

FIG. 2 is a schematic drawing illustrating the method for authoring media objects in an optical storage medium according to the present invention;

FIG. 2A is a schematic drawing illustrating the appearance of the built-in menu according to the presenting invention;

FIG. 3 is a schematic drawing illustrating a variant of the method for authoring media objects in an optical storage medium according to the present invention;

FIG. 4 is a schematic drawing illustrating the apparatus of authoring media objects in an optical storage medium according to the present invention and the operations that various units therein perform;

FIG. 5 is a schematic drawing illustrating the method of authoring media objects in an optical storage medium according to the present invention;

FIG. 6 is a flowchart illustrating the method for storing media objects in optical storage medium according to the present invention;

FIG. 7 is a schematic drawing illustrating an alternative method for authoring media objects in an optical storage medium according to the present invention, where the media objects are divided into two “albums”.

### DETAILED DESCRIPTION OF THE PREFERRED EMBODIMENT

In the following description, the term “button” refers to a Navigation Command which when selected by the user would be highlighted to indicate which button of functionality is to be activated. As stated above, the term “menu” refers to an Interactive Menu comprising MPEG stills or moving videos (usually referred to as “motion menu”) with overlaid sub-images or sub-videos for highlighting buttons, which are commonly seen in a DVD-Video disc prior to starting a movie title. The cooperation of “menus” and “buttons” is common to that in a DVD-Video disc for selecting different scenes in a movie, and changing language or subtitles options, accessing special features, etc. The term “media objects” refers to at least one media type such as, a still image and a video with or without accompanying audio. The term “still image” refers to a high-quality, single image that may have a resolution of 720×480 or 720×576 pixels or even higher, for example. The term “video” refers an image stream that may have a resolution of 720×480, 704×480, 352×480, 352×240 pixels for MPEG-2, 525/60 (NTSC), 720×576, 704×576, 352×576, 352×288 pixels for MPEG-2, 625/50 (PAL), 352×240 pixels for MPEG-1, 525/60 (NTSC), and 352×288 pixels for MPEG-1, 625/50 (PAL), for example. The term “optical storage medium” refers to any of CD-R, CD-RW, DVD+R, DVD-R, DVD+RW, DVD-RW, DVD-DL and any other under-developing similar optical-based storage medium capable of storing digital data, for example but not limited to a Blue-Ray DVD. The term “storage device” refers to a digital camera, digital camcorder, PVR, PC, a web server, flash memory, CF card, MMC card, SD card mini-SD card, and any other under-developing portable storage device.

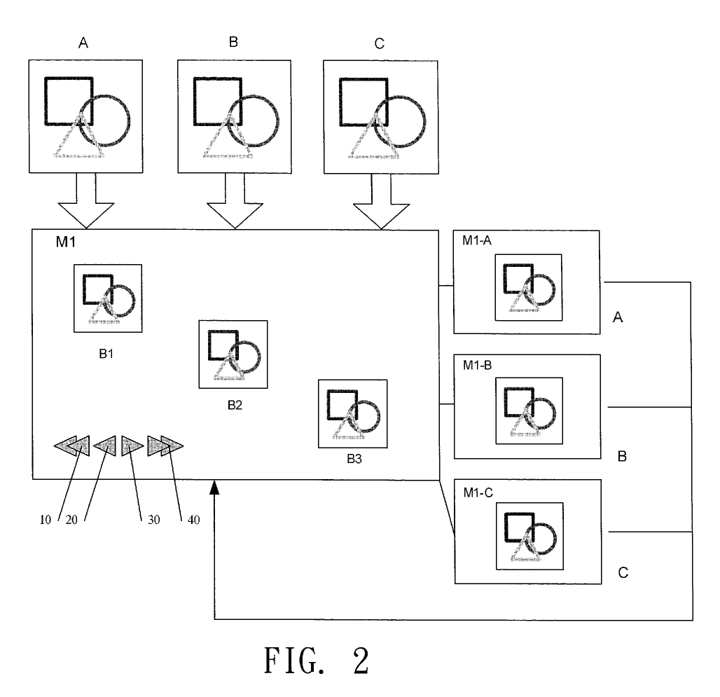

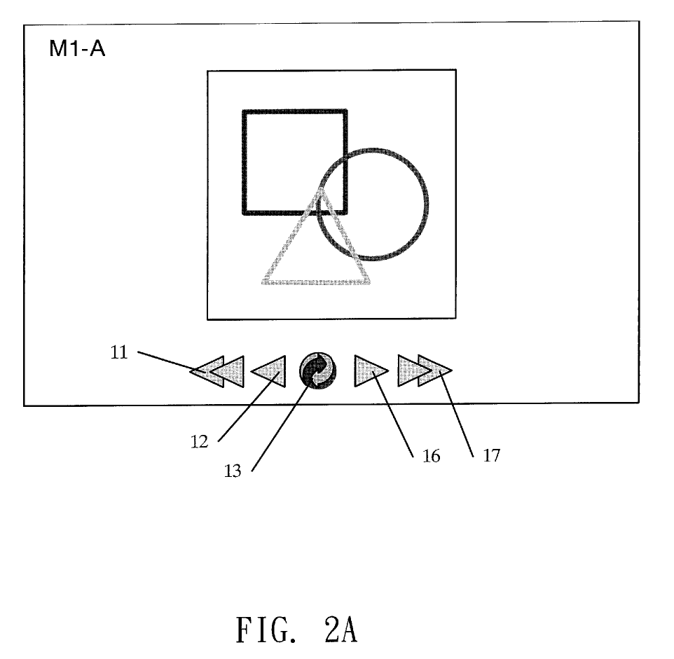

Reference is now made to FIG. 2, which depicts a schematic drawing illustrating the method for authoring media objects in an optical storage medium according to the present invention. According to the present invention, when a user intends to back media objects captured by a digital camera and stored in a storage device to an optical storage medium, apparatus employing the method for this invention would first read the media objects, such as images A, B and C in FIG. 2, and then provide two or more built-in menus, represented by one numerated as M1 in FIG. 2, wherein each built-in menu Menu1 including at least one built-in navigation command 10, 20, 30, 40. The media objects A, B, C are then each associated to a dedicated navigation command B1, B2, B3 so as to establish a one-on-one relationship between the media objects A, B, C and the navigation commands B1, B2, B3. The apparatus then arranges the navigation commands B1, B2, B3 such that the navigation commands are distributed among the built-in menus M1, M2, etc. and define the media objects each to be a menu M1-A, M1-B, M1-C. In actual practice, there will be more than three media objects to be stored in the optical storage medium. Thus, there will be more than one built-in menu, such as M1, M2, M3 and so on, to be stored in the optical storage medium. The actual number of built-in menus may depend on the total number of media objects and the pre-defined or user-defined number of navigation commands/buttons to be included in a built-in menu. Fore example, if there are a total of 300 media objects and number of navigation commands/buttons to be included in a built-in menu is pre-defined or user-defined to be 3, as shown in FIG. 2, there will be a total of 100 built-in menus stored in the optical storage medium.

To allow easy identification of the media objects A, B, C associated to the navigation commands B1, B2, B3, the navigations commands should be presented as buttons with overlaid and possibly reduced-size sub-media objects. The configuration of the built-in navigation commands 10, 20, 30, 40, on the other hands, may be pre-defined according to their functionalities, which may include, but are not limited to, a Home command, an End Command, a Backward command and a Forward Command whereby activation of such commands would navigate to a first, last, preceding and succeeding built-in menu, respectively. According to the DVD specification approved by the DVD forum, each menu may include a maximum of 36 buttons. Thus, each menu should be authored to meet such a specification.

According to one embodiment of this invention, the media objects A, B, C, in addition to be associated to a dedicated navigation command, B1, B2, B3, are each defined to be a menu M1-A, M1-B and M1-C in the optical storage medium as stated above. Accordingly, upon activation of the navigation commands B1, B2, B3, the menus M1-A, M1-B, M1-C will be displayed as shown in FIG. 2. Each menu M1-A, M1-B, M1-C may further comprises a Home button or function11, a Backward button or function12, a Return button or function13, a Forward button or function16 and an End button or function17, and every button or function be provided with at least one built-in navigation command, best shown in FIG. 2A. The user can navigates to a first media object in the menu, a last media object in the menu, a preceding media object in the menu, a succeeding media object in the menu and a menu containing current menu by activation of the Home, End, Backward, Forward and Return button or function. Such navigations commands may be those that have been defined by the DVD specification.

If the media object were a video in the form of mpeg, mpg, wmv, m2v, avi, rm, rmvb, asf, mov, mkv, mpe, xvid, divx, dat, bik, mv2, ra, dv, vob, etc files, which may necessarily be converted into Mpeg2 files that may be accessed by DVD-Video discs, which is well known by persons skilled in the art and not described in details herein and limited to a still image in the form of JPG, BMP, TIFF, TGA, PNG, PCX, PICT, PCT, SD, CRW, CIN, WMZ, CGM, CMX, DGN, DIC, DJVU, CUT, DRW, DXF, DWF, DWG, EPS, ECW, SHP, FIT, FLC, GBR, IFF, JBG, KDC, DCR, DCS, PCT, CLP, SID etc. files, the menu would be a motion menu defined in the optical storage medium. Alternatively, the video title may be associated with a video title (similar to a chapter in a DVD Video disc).

After completing the above authoring process, the built-in menus, media objects defined by the menus, the navigation commands associated to the corresponding media objects/menus and overlaying the built-in menus are recorded in the optical storage medium.

According to this invention, the total number of media objects that can be authored and stored in an optical storage medium is essentially limited by the total capacity of the optical storage medium, for reasons stated below.

Using still images as the media objects, for examples, a high-quality, full-color still image usually ranges from 0.6 MB to 1.5 MB, usually calculated to be three times (R, G, B bytes) of the resolution (such as 720×480 pixels) and depending on the formats and compression ratio of the image files. Since the DVD forum defines the maximum number of Menus that may be recorded in an optical storage medium, is 3,243,933 (99×32,767), the capacity of optical storage medium would have been long exhausted prior to actually recording the maximum number of media objects, even if the total number of “built-in menus” has been taken into consideration and subtracted from such maximum number, in one optical storage medium. Accordingly, this invention allows authoring of the one-on-one relationship between the media objects and the navigation commands to be of a number that is substantially limited by capacity of the optical storage medium, but not the DVD Specification approved by the DVD forum.

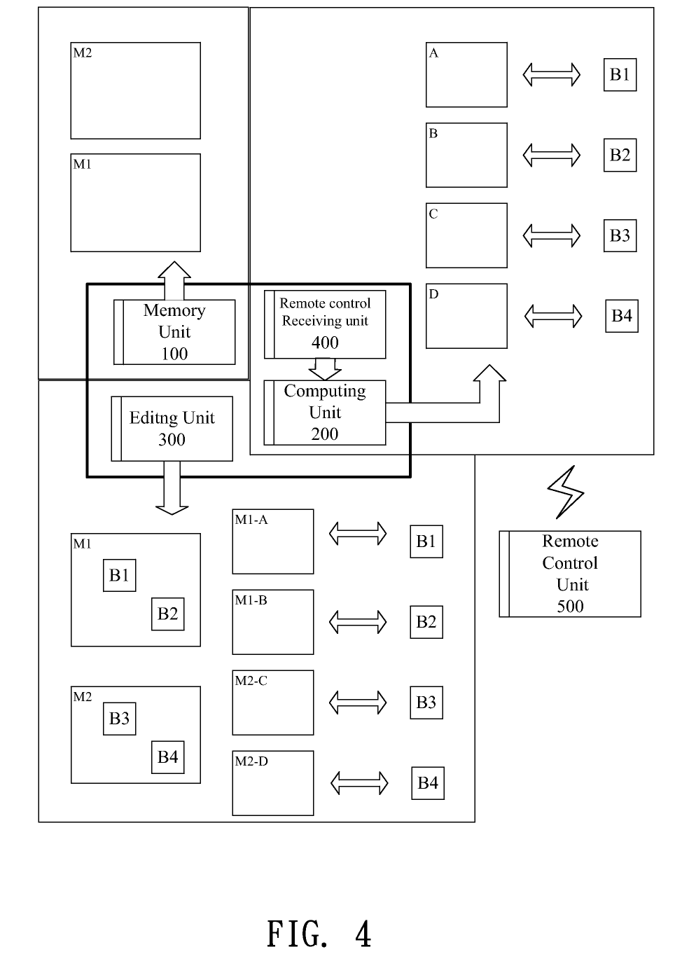

Please refer to table 1, which shows how the authoring media object of the present invention is navigated to an optical storage medium. For the purpose of aforesaid navigation function, we practice the all presented screens by DVD menu, for example, a general DVD Video totally uses 14 menus, wherein, the first menu is an album catalog, the second to fifth menu is browsing portion of the photo album, the 6^{th} to 13^{th} menu is browsing portion of each photo, the 14^{th} menu is a blank menu for special condition. Besides creating the menus, each button or function between menus of the present invention uses the navigation commands between each menu, and uses these navigation commands to achieve the goal of browsing the photo album. For example, we can set a shrank button (shown in FIG. 4) in the menu 04 (the 3^{rd} page of the photo album), so that the menu 04 can be connected to the menu 11 (the 6th page of the album) for browsing a photo when the shrank button is executed. There will cause many misconnecting when uses at least one set VTS to dispose the menu according to the DVD specification. Therefore, the method of the present invention uses many navigation commands in the first and last menu (for example but not limited to an empty menu), so as to let the judgment process can connect to the correct menu.

TABLE 1

| Menu No. | description |
|---|---|
| Menu 01 | album catalog |
| Menu 02 | the first page of the album |
| Menu 03 | the second page of the album |
| Menu 04 | the third page of the album |
| Menu 05 | the fourth page of the album |
| Menu 06 | first photo |
| Menu 07 | second photo |
| Menu 08 | third photo |
| Menu 09 | fourth photo |
| Menu 10 | fifth photo |
| Menu 11 | sixth photo |
| Menu 12 | seventh photo |
| Menu 13 | eighth photo |
| Menu 14 | empty Menu |

Please refer to table 2, here using the aforesaid DVD video as an example; the original data have a VTS. When we add a new VTS in the DVD video, and we want to connect the menu 15 (5^{th} page of the album) to menu 05 (4^{th} page of the album). The method of the present invention sets a set of navigation commands in the previous page button of the menu 15 (5^{th} page of the album), and sets a series navigation commands in menu 01 and menu 21. Therefore, when the user presses the preceding page button of the menu 15 (5^{th} page of the album), the button will set a parameter (for example G=1), and connects to menu 21, then the navigation commands of the menu 21 will judge the parameters and decide which connection will be executed. The menu 21 will connect to the VST01 according to the set parameter (G=1) and connects to the menu 05 by the set navigation commands of the first menu (i.e. menu 01) of the VST01, so as to complete the browsing process.

TABLE 2

| VTS 01 | | VTS 02 | |
|---|---|---|---|
| Menu No. | description | Menu No. | description |
| Menu 01 | album catalog | Menu 15 | the fifth page of the |
| Menu 02 | the first page of the | | album |
| | album | Menu 16 | the sixth page of the |
| Menu 03 | the second page of | | album |
| | the album | Menu 17 | the seventh page of |
| Menu 04 | the third page of the | | the album |
| | album | Menu 18 | ninth photo |
| Menu 05 | the fourth page of | Menu 19 | tenth photo |
| | the album | Menu 20 | eleventh photo |
| Menu 06 | first photo | Menu 21 | empty Menu |
| Menu 07 | second photo | | |
| Menu 08 | third photo | | |
| Menu 09 | fourth photo | | |
| Menu 10 | fifth photo | | |
| Menu 11 | sixth photo | | |
| Menu 12 | seventh photo | | |
| Menu 13 | eighth photo | | |
| Menu 14 | empty Menu | | |

FIG. 4 is a schematic drawing illustrating the apparatus of authoring media objects in an optical storage medium according to the present invention, which is enclosed by a heavier solid rectangle, and the operations that various units therein perform. As shown in FIG. 4, the apparatus adopting the above authoring method may include a memory unit 100 for providing two or more built-in menus M1, M2 . . . , each built-in menu M1, M2 including at least one built-in navigation command as described above. The apparatus may further include a computing unit 200 for associating the media objects A, B, C, D each to a dedicated navigation command B1, B2, B3, B4 so as to establish a one-on-one relationship between the media objects A, B, C, D and the navigation commands B1, B2, B3, B4 in the optical storage medium. An editing unit 300 is further provided for arranging the navigation commands B1, B2, B3, B4 such that they are distributed among the built-in menus M1, M2 . . . , and for defining the media objects A, B, C, D each to be a menu M1-A, M1-B, M2-C, M2-D for displaying the media objects A, B, C, D. Furthermore, the apparatus of authoring media objects in an optical storage medium according to the present invention further comprises a remote control receiving unit 400 and a remote control transmitting unit 500. Wherein, the remote control receiving unit 400 is coupled to the computing unit 200 for receiving the command transmitted from the remote control transmitting unit 500. The remote control transmitting unit 500 can transmit the navigation commands to the remote control receiving unit 400 for switching the navigation commands.

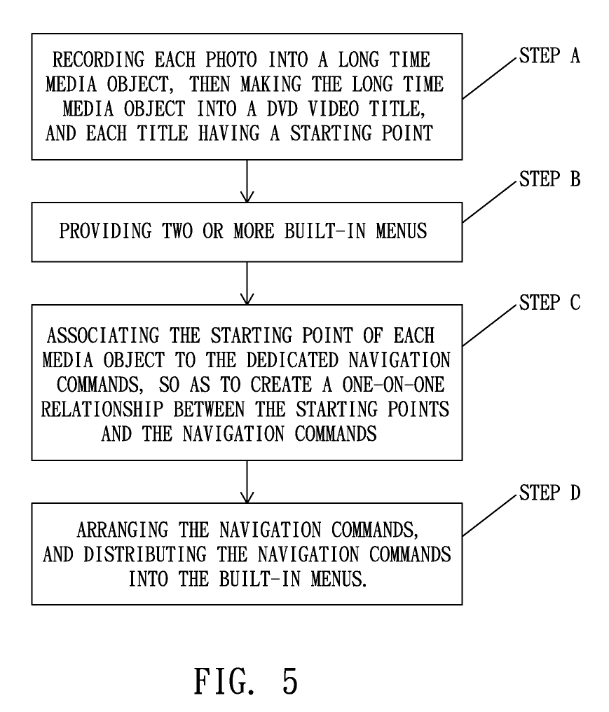

FIG. 5 is a schematic drawing illustrating the method of authoring media objects in an optical storage medium according to the present invention, as shown in the figure, the method of authoring media objects in an optical storage medium according to the present invention comprises the steps of: (a) recording each photo into a long time media object, then making the long time media object into a DVD video title, and each title having a starting point; (b) providing two or more built-in menus; (c) associating the starting point of each media object to the dedicated navigation commands, so as to create a one-on-one relationship between the starting points and the navigation commands; and (d) arranging the navigation commands, and distributing the navigation commands into the built-in menus.

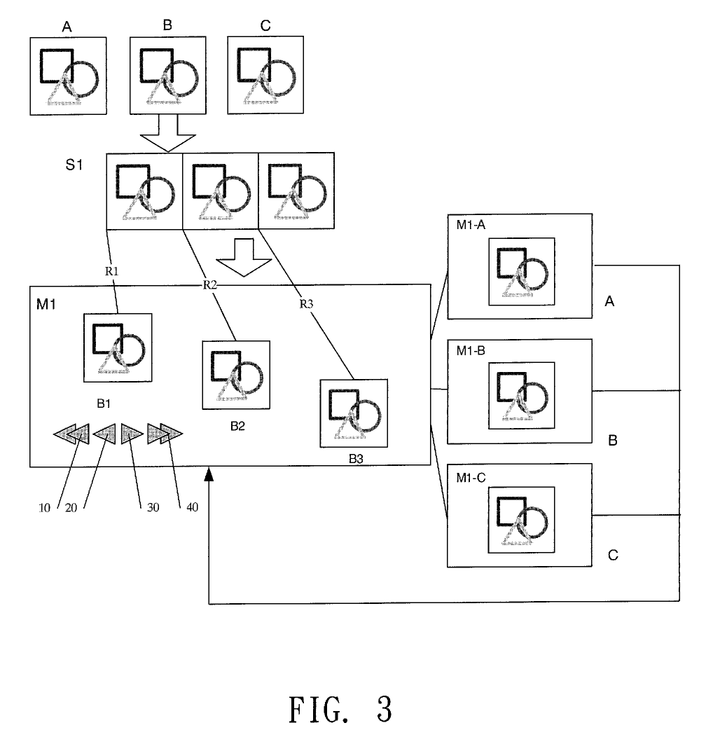

According to a variant of this invention, a fixed number of still images A, B, C may also be converted into a media object having segments of such still images, such as a Video Title, with a fixed duration of interval between two consecutive still images, but still achieve the intended one-on-one relationship. In this embodiment, when a user intends to back still images captured by a digital camera and stored in a storage device to an optical storage medium, apparatus employing the method for this invention would first read the media objects, such as images A, B, C and then provide two or more built-in menus, wherein each built-in menu M1, M2 and etc. including at least one built-in navigation command described above for the embodiment in FIGS. 2 and 2A. The media objects A, B, C are then converted into individual media objects in the form of Video Title, with the starting points of the segments defined by the still images A, B, C each associated to a dedicated navigation command B1, B2, B3 so as to establish a one-on-one relationship R1, R2, R3 between the starting points of the segments A, B, C and the navigation commands B1, B2, B3, wherein a relatively long period of time is defined between two consecutive segments A, B, C so as to provide the user with the misconception that only one image is displayed. The apparatus then arranges the navigation commands B1, B2, B3 such that the navigation commands are distributed among the built-in menus M1, M2, etc. and define the media objects each to be a Video Title S1, as shown in FIG. 3. In actual practice, there will be more than three media objects to be stored in the optical storage medium. Thus, there will be more than one built-in menu, such as M1, M2, M3 and so on, to be stored in the optical storage medium. While viewing the still images A, B, C authored by this method, the user may use the “Menu,” “Return,” and “Next” buttons provided by the DVD-players to switch to the original built-in menu (such as from viewing of image A to built-in menu M1), the prior still image and the next still image. The relationship among various built-in menus M1, M2 and M3 is similar to the prior embodiment and thus not repeated herein. In this embodiment, the Video Title S1 would resemble a video divided into more than one chapter, such as that commonly seen in a movie title. As a relatively long period of time is defined between two segments A, B, C, the user usually would not have the chance to view the following segment before using the “Menu,” “Return,” and “Next” buttons provided by the DVD-players to switch to the original built-in menu.

As compared to the embodiments illustrated in FIGS. 2 and 2A that establish a one-on-one relationship between the media objects and the navigation commands, the method for authoring media objects in the above embodiment associates each starting point of the segments of the media objects to a dedicated navigation command so as to establish a one-on-one relationship between the starting points of the segments and the navigation commands, which are then arranged to be distributed among the built-in menus. The apparatus adopting the above authoring method may include a memory unit similar to the embodiment shown in FIGS. 2 and 2A. The apparatus may further include a computing unit for associating each starting point of the segments A, B, C of the media objects S1 and etc. to a dedicated navigation command B1, B2, B2 so as to establish a one-on-one relationship R1, R2, R3 between the starting points of the segments A, B, C and the navigation commands B1, B2, B3. An editing unit is further provided for arranging the navigation commands B1, B2, B3 such that they are distributed among the built-in menus M1, M2, and etc.

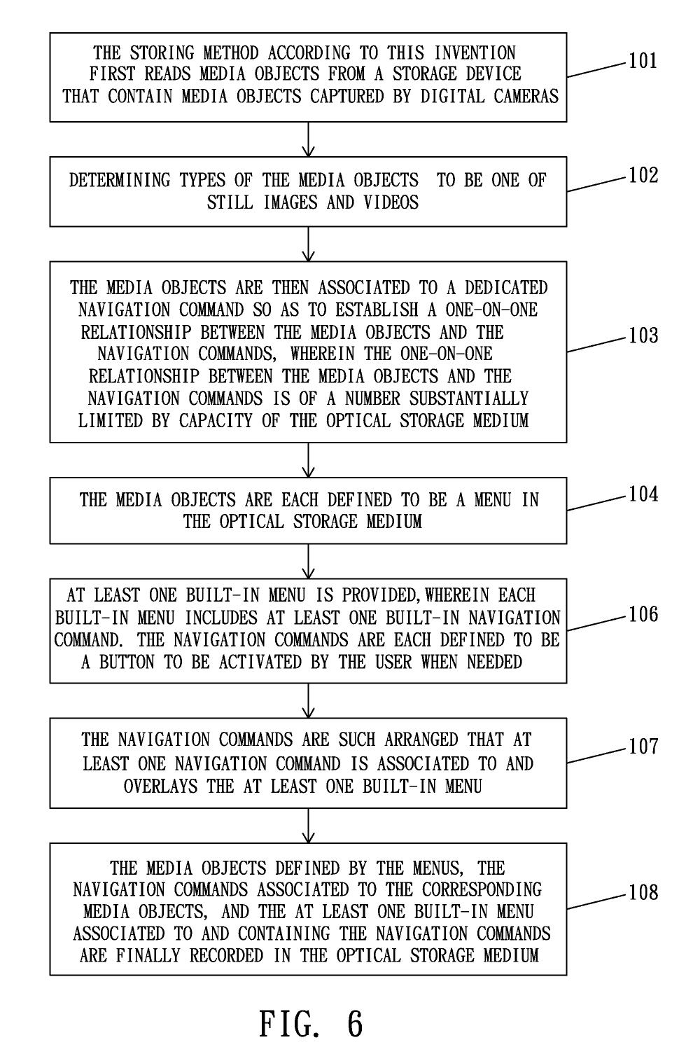

FIG. 6 flowchart showing the method for storing media objects in optical storage medium according to the embodiment shown in FIGS. 2 and 2A of the present invention. As shown in FIG. 6, in step 101, the storing method according to this invention first reads media objects from a storage device that contain media objects captured by digital cameras. In step 103, the media objects are then associated to a dedicated navigation command so as to establish a one-on-one relationship between the media objects and the navigation commands, wherein the one-on-one relationship between the media objects and the navigation commands is of a number substantially limited by capacity of the optical storage medium. In Step 104, the media objects are each defined to be a menu in the optical storage medium. In Step 106, at least one built-in menu is provided, wherein each built-in menu includes at least one built-in navigation command. The navigation commands are each defined to be a button to be activated by the user when needed. In Step 107, the navigation commands are such arranged that at least one navigation command is associated to and overlays the at least one built-in menu. In Step 108, the media objects defined by the menus, the navigation commands associated to the corresponding media objects, and the at least one built-in menu associated to and containing the navigation commands are finally recorded in the optical storage medium.

Prior to Step 103, the method may optionally include a step 102 of determining types of the media objects to be one of still images and videos. Accordingly, if the media objects are determined to be a video, the media objects may be defined to be one of a video title and a motion menu in the optical storage medium. Such a step may be not needed if it is known in advance that all media objects are of still images or videos.

In actual practice, the apparatus that employ the authoring method and storing method described above may be a PC or a home appliance loaded with an application, or a chip embedded with a firmware. The term “apparatus” does not intend to limit the physical devices carrying out the above methods to be of any particular form, size or application. The exemplary apparatus may include a means for reading the media objects from the storage device; such as a removable or non-removable card reader serving as an interface for accessing media objects stored in various storage devices. The apparatus may further include a means for associating the media objects each to a dedicated navigation command, a means for defining the media objects each to be a menu, and a means for arranging the navigation commands such that at least one navigation command overlays at least one built-in menu predetermined by the apparatus, where an exemplary means for implementing the various aspects of the invention may include a processing unit loaded with an application or embedded with a firmware capable of such operations. The processing unit may be any of available processors and chips. Dual microprocessors and other multiprocessor architectures also can be employed as the processing unit. The apparatus may further be equipped with suitable memory units pre-loaded with built-in menus and built-in navigation commands. After the necessary processing, the apparatus further implements a means for recording the media objects, the navigation commands, and the built-in menu to the optical storage medium, where such means may include, but not limited, to a recordable optical disk drive such as a CD-R drive, CD-RW drive, DVD-R drive, or DVD-RW drive.

Although novice PC and electronic appliance user tends not to edit the order of the media objects and to have the apparatus author and store the media objects automatically without any human involvement, some users may wish to “re-arrange” the order of the media objects or to “categorize” the media objects prior to storing the media objects in the optical storage medium. To this end, the apparatus implementing this invention may, alternatively, provide the user with the option to re-arrange or categorize the media objects stored in the storage device prior to storing the media objects in the optical storage medium. Such an “edition” and “categorization” function may be or may not be a part of the “apparatus.”

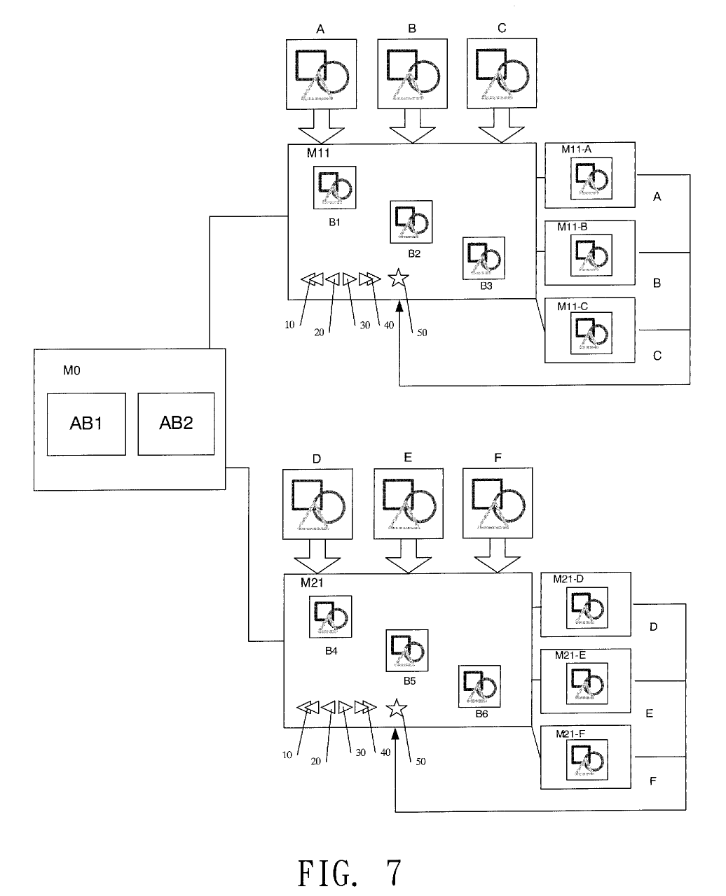

FIG. 7 is a schematic drawing illustrating an alternative method for authoring media objects in an optical storage medium according to the present invention, where the media objects have been “edited” or “categorized” by the user into more than one “album,” where still images A, B, C and etc. are grouped in a first album and still images D, E, F and etc. are grouped in a second album. As shown in FIG. 6, a first level of built-in menu M0 is provided with two navigation buttons AB1 and AB2 that are associated to a second level of built-in menus M11, M21, respectively. The structure of the built-in menus M11, M21 is identical to that of M1 illustrated in FIG. 2, other than that an additional Root Command 50 may be provided to the second level of built-in menus M11, M21 and etc. for returning to the first level of built-in menu M0. In actual practice, there will be more than three media objects to be stored in each album AB1, AB2 in the optical storage medium. Thus, there will be more than one series of built-in menu, such as M11, M12, M13 and so on as well as M21, M22, M23, to be grouped and related to the navigation commands AB1 and AB2. It can be appreciated that more albums may be authored and stored in one optical storage medium in accordance with the user's needs.

According to the present invention, when a user intends to back up media objects captured by a digital camera and stored in a storage device to an optical storage medium, the user would only need to connect the storage device to the apparatus employing the authoring and/or recording method of this invention. While viewing the media objects that have been authored and stored to the optical storage medium, the user can easily locate the specific still images of interest from multiple navigation commands associated with corresponding built-in menus, by navigating through the built-in menus with the built-in navigation commands, since the navigation commands associated with corresponding media objects are overlaid with sub-images or sub-videos of the associated media objects. The user does not need to wait until any preceding still images to be displayed before he/she can actually locate the still images of interest. After the user has located the navigation command associated with the media object of interest, activation of the navigation command would display nothing but the media object of interest. Such a viewing approach mimics the conventional “album-like” viewing habit known by the user who can flip through the built-in menus, stop at any image of interest, and/or take a closer look of the image of interest. The built-in menu can even be designed to resemble the “leaves” of a photo album to provide the user with a familiar operation environment. The user may freely flip to the next built-in menus to continue viewing of the images as he/she has been doing with physical photo albums.

Most people consider DVD-Video discs as a medium for playing back movie titles, where menus in the DVD-Video discs are mainly used to link or playback a specific video chapter, or link to another sub-menu, such as for selecting the language and subtitle. In this invention, however, the property that a menu can be linked to another menu is fully implemented to allow hierarchical browsing of media objects. That is, a menu can serve as an index menu, such as in the form of a built-in menu, as well as the means for displaying the media object per se, such as in the form of a motion menu or menu defined by the media objects, where such two types of menus may be related to each other in various manners, such as using the navigation commands capable of browsing a very first, a last, next and prior menu. In particular, this invention implements menus that have been well defined by the DVD specification, by defining media objects as menus commonly used in DVD-Video discs and authoring the relationship among the menus and navigation commands on different menus to create an “album-like optical storage medium.”

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

What is claimed is:

1. A method for authoring media objects stored in an optical storage medium, comprising the steps of:
(a) providing two or more built-in menus, each built-in menu including at least one built-in navigation command;
(b) associating the media objects each to a dedicated navigation command so as to establish a one-on-one relationship between the media objects and the navigation commands, wherein the one-on-one relationship between the media objects and the navigation commands is of a number substantially limited by capacity of the optical storage medium; and
(c) arranging the navigation commands such that the navigation commands are distributed among the built-in menus and defining the media objects each to be a menu.

2. The method of claim 1, wherein the built-in menu further comprises a Home button or function, a Backward button or function, a Return button or function, a Forward button or function and an End button or function, and every button or function be provided with at least one built-in navigation command, therefore, the user can browse to a first built-in menu, a last built-in menu, a built-in menu containing current menu, preceding built-in menu and succeeding built-in menu, respectively by executing the Home button or function, Backward button or function, Return button or function, Forward button or function or End button or function.

3. The method of claim 1, wherein the one-on-one relationship enables displaying of the media objects upon activation of the associated navigation commands, wherein the media objects is displayed as a menu defined by the media objects, and the menu further comprises at least one built-in navigation command.

4. An apparatus for authoring media objects stored in an optical storage medium, comprising:
(a) a memory unit for providing two or more built-in menus, each built-in menu including and at least one built-in navigation command;
(b) a computing unit for associating the media objects each to a dedicated navigation command so as to establish a one-on-one relationship between the media objects and the navigation commands, wherein the one-on-one relationship between the media objects and the navigation commands is of a number substantially limited by capacity of the optical storage medium; and
(c) an editing unit for arranging the navigation commands such that the navigation commands are distributed among the built-in menus and for defining the media objects each to be a menu.

5. The apparatus of claim 4, wherein the built-in menu further comprises a Home button or function, a Backward button or function, a Return button or function, a Forward button or function and an End button or function, and every button or function be provided with at least one built-in navigation command, therefore, the user can browse to a first built-in menu, a last built-in menu, a built-in menu containing current menu, preceding built-in menu and succeeding built-in menu, respectively by executing the Home button or function, Backward button or function, Return button or function, Forward button or function or End button or function.

6. The apparatus of claim 5, wherein the one-on-one relationship enables displaying of the media objects upon activation of the associated navigation commands, wherein the media objects is displayed as a menu defined by the media objects, and the menu further comprises at least one built-in navigation command.

7. The apparatus of claim 6, wherein the built-in menu further comprises a Home button or function, a Backward button or function, a Return button or function, a Forward button or function and an End button or function, and every button or function be provided with at least one built-in navigation command, therefore, the user can browse to a first built-in menu, a last built-in menu, a built-in menu containing current menu, preceding built-in menu and succeeding built-in menu, respectively by executing the Home button or function, Backward button or function, Return button or function, Forward button or function or End button or function.

8. The apparatus of claim 6, further comprising a remote control receiving unit and a remote control transmitting unit for switching the media objects.

9. A method for storing media objects in an optical storage medium, comprising the steps of:
(a) reading media objects from a storage device;
(b) associating the media objects each to a dedicated navigation command so as to establish a one-on-one relationship between the media objects and the navigation commands, wherein the one-on-one relationship between the media objects and the navigation commands is of a number substantially limited by capacity of the optical storage medium; and
(c) recording the media objects and the navigation commands associated to the corresponding media objects to the optical storage medium.

10. The method of claim 9, further comprising the step of defining the media objects each to be a menu in the optical storage medium after step (b).

11. The method of claim 9, wherein activation of the navigation commands displays the menus defined by the corresponding media objects associated thereto.

12. The method of claim 9, further comprising the steps of:
(a-1) determining types of the media objects to be one of still images and videos.

13. The method of claim 12, further comprising the step of defining the still images each to be a menu in the optical storage medium after step (c) if the media objects are a still image, or defining the media objects each to be one of a motion menu and a video title in the optical storage medium after step (c) if the media object is a video.

14. The method of claim 13, wherein activation of the navigation commands displays the menu defined by the corresponding still images or video associated thereto.

15. The method of claim 12, further comprising the step of defining the media objects each to be one of a motion menu and a video title in the optical storage medium after step (c) if the media object is a video, wherein activation of the navigation commands displays the motion menu or video title defined by the corresponding videos associated thereto.

16. An apparatus for storing media objects in an optical storage medium, comprising:
(a) means for reading media objects from a storage device;
(b) means for associating the media objects each to a dedicated navigation command so as to establish a one-on-one relationship between the media objects and the navigation commands, wherein the one-on-one relationship between the media objects and the navigation commands is of a number substantially limited by capacity of the optical storage medium; and
(c) means for recording the media objects and the navigation commands associated to the corresponding media objects to the optical storage medium.

17. The apparatus of claim 16, wherein the media objects includes still images and videos.

18. A method for storing media objects in an optical storage medium, comprising the steps of:
(a) recording each photo into a long time media object, then making the long time media object into a DVD video title, and each title having a starting point;
(b) providing two or more built-in menus;
(c) associating the starting point of each media object to the dedicated navigation commands, so as to create a one-on-one relationship between the starting points and the navigation commands; and
(d) arranging the navigation commands, and distributing the navigation commands into the built-in menus.

19. The method of claim 18, wherein the media object is a video divided into more than one chapter.

20. The method of claim 18, wherein activation of the navigation commands displays the media object from the respective starting point associated thereto.

21. The method of claim 18, wherein the built-in menu further comprises a Home button or function, a Backward button or function, a Return button or function, a Forward button or function and an End button or function, and every button or function be provided with at least one built-in navigation command, therefore, the user can browse to a first built-in menu, a last built-in menu, a built-in menu containing current menu, preceding built-in menu and succeeding built-in menu, respectively by executing the Home button or function, Backward button or function, Return button or function, Forward button or function or End button or function.

22. The apparatus of claim 18, wherein the one-on-one relationship can make the media object be displayed when the related navigation command is executed.

23. The apparatus of claim 18, wherein the length of the media object is 1˜10 minute(s).
